(19) United States
(12) Patent Application Publication
(10) Pub. No.: US 2001/0008672 A1
(43) Pub. Date: Jul. 19, 2001

(54) FLOCKED ARTICLES

(76) Inventors: JEAN NORVELL, NEWARK, DE (US); PHILIP L. WAGNER, CHADDS FORD, PA (US)

Correspondence Address: CAROL A LEWIS, W L GORE & ASSOCIATES INC, 551 PAPER MILL ROAD, PO BOX 9206, NEWARK, DE, 197149206

(21) Appl. No.: 09/015,616

(22) Filed: Jan. 29, 1998

Related U.S. Application Data
(63) Continuation-in-part of application No. 08/618,944, filed on Mar. 20, 1996, now abandoned.

(51) Int. Cl. B32B 5/08; B32B 33/00

(52) U.S. Cl. 428/90; 428/422; 442/76; 442/85; 442/86

(57) ABSTRACT

Novel flocked articles are disclosed which include as at least one component of the article a water resistant, wind resistant, breathable portion. The water resistant, wind resistant, breathable portion may be a membrane, layered structure or composite which is either porous or nonporous, which can also be air permeable or air impermeable, hydrophilic, hydrophobic and/or oleophobic. In a particularly preferred embodiment of the present invention, at least a portion of the article comprises an ePTFE material. The flocked article may have any desired shape, such as a flexible sheet, a fabric, a fiber, a flexible or rigid three-dimensional shape, a tube, or the like. Moreover the configuration of the article may be either simple or complex, ranging from a single sheet to a layered structure to a multi-layered, multi-compositional form.

### RELATED APPLICATIONS

The present application is a continuation-in-part of copending U.S. patent application Ser. No. 08/618,944 filed Mar. 20, 1996.

### FIELD OF THE INVENTION

The present invention relates to novel flocked articles which include as at least one component of the article a water resistant (i.e., liquid water or water-based liquid impermeable), wind resistant, breathable (i.e., moisture vapor permeable or air permeable) portion. The water resistant, wind resistant, breathable portion may be a membrane, layered structure or composite which is either porous or nonporous, which can also be air permeable or air impermeable, hydrophilic, hydrophobic and/or oleophobic. In a particularly preferred embodiment of the present invention, at least a portion of the article comprises an expanded polytetrafluoroethylene (ePTFE) material. The flocked article may have any desired shape, such as a flexible sheet, a fabric, a fiber, a flexible or rigid three-dimensional shape, a tube, or the like. Moreover the configuration of the article may be either simple or complex, ranging from a single sheet to a layered structure to a multi-layered, multi-compositional form.

### BACKGROUND OF THE INVENTION

Flocking is the application of fine particles to adhesively prepared surfaces. The fine particles may be either natural or synthetic, and the resulting flocked finish, depending on the nature of the material comprising the flock, imparts decorative and/or functional characteristics to the surface. Flocked materials typically have a velvet-like appearance, which can be enhanced to give a deeper luster or changed to confer a less reflective surface. The changes in appearance and texture can be accomplished based upon the composition and geometry of the flock material chosen.

The technique of flocking can be traced back circa 1000 B.C., and the field of flocking is replete with techniques for achieving desirable flocked finishes, such as matte, high sheen, sculptured surfaces, low friction, high friction, iridescence, colors, etc. Moreover, high strength, abrasion-resistant, and highly durable flocked surfaces are available.

Flocked surfaces have been utilized in a wide variety of textile and industrial applications to achieve decorative and visual appeal, friction modification, wear resistance, sound dampening, heat insulation and thermal stability, increased surface area for filtration and evaporation, transitionless power transmission, liquid retention or dispersal, buffing, polishing and cushioning. Moreover, flocking is a highly desirable manufacturing technique due to the simple, quick and inexpensive nature of the processing.

Ongoing efforts to improve the performance of flocked materials for use in a variety of commercial and industrial applications have resulted in materials with unique properties. For example, fire-resistant and flame-retardant flocked fabrics are taught in U.S. Pat. Nos. 5,320,890, and 4,076,878, whereby fire and flame resistant materials are incorporated as components of the flocked fabrics. Moreover, flocked fabrics incorporating bacterial barriers are taught in U.S. Pat. Nos. 4,308,303 and 4,353,945.

Flocked fabric laminates for protection against chemical agents are taught in U.S. Pat. No. 4,459,332, to Giglia. In this patent, air and water vapor permeable, toxic vapor absorptive fabric materials are formed of (1) a first inactive, woven or non-woven fabric, (2) a first air and water permeable open-celled adhesive foam layer having activated carbon fiber flocking positioned substantially perpendicular to the surface thereof away from the first layer of fabric and activated carbon powder deposited in the voids formed between the flocking, (3) a second air and water vapor permeable open-celled adhesive foam layer, and (4) a second inactive, woven or non-woven fabric. In one embodiment, the inactive, woven or non-woven fabric layers may be rendered hydrophobic by coating with porous silicone film or a polymer such as polytetrafluoroethylene.

U.S. Pat. No. 5,126,182, to Lumb et al., is directed to a drapable, water vapor permeable, wind and water resistant composite fabric comprising a fabric substrate, a foamed water vapor porous adhesive of acrylic latex or acrylic polyurethane, an adhesive barrier material, such as aluminum wax, to keep the adhesive substantially in the surface region of the fabric, and a layer of flock fibers or a fabric layer adhered to and covering the adhesive layer.

U.S. Pat. No. 5,026,591, is directed to coated products comprising a substrate of a microporous scaffold, such as expanded PTFE, having a high void volume and open, interconnecting microstructure, the voids being substantially filled with a chemical substance. In one embodiment, a loose cotton fiber flocking can be married onto the coating surface as the material is wrapped onto a core to prevent sticking of the material to itself during wrapping.

These patents are representative of flocked materials which have been adapted to meet a variety of needs. However, to date, the art has been unable to provide a simple, economical process for the production of novel, water resistant, breathable articles having flocked surfaces which are lightweight, resilient (e.g., resistant to wear), insulative, and with increased surface area and expanded functionality for use in a virtually unlimited number of textile and industrial applications.

Accordingly, it is a purpose of the present invention to provide novel flocked articles which include as at least one component of the article a flocked, water resistant, wind resistant, breathable membrane, layered structure or composite which is either porous or nonporous, which can also be air permeable or air impermeable, hydrophilic, hydrophobic and/or oleophobic.

Moreover, it is another purpose of the present invention to provide novel flocked articles comprising an expanded polytetrafluoroethylene (ePTFE) as at least one component thereof.

Moreover, it is a further purpose of the present invention to provide novel flocked fabric assemblies which are resilient, lightweight and insulative with a greater surface area than conventional fabrics, while providing enhanced tailorability to suit a desired need in a highly economical manner.

It is a further purpose of the present invention to provide novel flocked articles for application in a variety of industrial products for such applications as filtration, insulation, and the like.

These and other purposes of the present invention will become evident based upon a review of the following specification.

### DISCUSSION OF COMMONLY OWNED PATENTS

One material which has exhibited extremely beneficial properties is an ePTFE as disclosed in U.S. Pat. Nos. 3,953,566, 3,962,153, 4,064,214, 4,096,227, 4,187,390 and 4,902,423, all assigned to W. L. Gore and Associates, Inc., and all of which are specifically incorporated herein by reference. This ePTFE material comprises a microporous structure of microscopic polymeric fibrils (i.e., thread-like elements) interconnecting polymeric nodes (i.e., particles from which the fibrils emerge). As the term “expanded PTFE” is used herein, it is intended to include any PTFE material having a node and fibril structure, including in the range from a slightly expanded structure having fibrils extending from relatively large nodes of polymeric material, to an extremely expanded structure having fibrils merely intersecting with one another at nodal points.

Expanded PTFE has a number of important properties which make it particularly desirable as a component in a wide variety of textile and industrial applications. First, ePTFE is a highly inert material that is hydrophobic. Accordingly, the material is resistant to interactions with liquid water or other water-based liquids which it may come into contact with during use. Additionally, by expanding PTFE in the manner taught by U.S. Pat. No. 3,953,566 to form the node and fibril structure, the material undergoes a significant increase in tensile strength and becomes highly flexible. Further, the material can be formed in many convenient to use forms, such as tapes, membranes, tubes, rods, three-dimensional shapes, etc.

Incorporation of a filler into an expanded PTFE matrix during the processing is possible, such as disclosed in U.S. Pat. No. 4,985,296, which is specifically incorporated herein by reference. This technique, among other things, maintains access to surface area of the filler by suspending filler particles by fine strands of ePTFE. Handling of the fillers is simplified owing to the flexible nature of the expanded PTFE/filler composite, as compared to use of the fillers in powder form.

Materials which incorporate, at least in part, the expanded PTFE disclosed in the commonly owned patents mentioned above have been developed to optimize material performance under various conditions. For example, U.S. Pat. Nos. 4,194,041, 5,026,591, 5,391,426, 5,385,694, 5,376,441, and 5,460,872 are directed to materials which optimize material performance when subjected to specific environmental conditions.

All of the above-mentioned commonly owned patents are specifically incorporated herein by reference.

### SUMMARY OF THE INVENTION

The present invention relates to novel flocked articles which include as at least one component of the article a water resistant, wind resistant, breathable portion. The water resistant, wind resistant, breathable portion may be in the form of a membrane, layered or composite structure which is either porous or nonporous, which can also be air permeable or air impermeable, hydrophilic, hydrophobic and/or oleophobic. The water resistant, wind resistant, breathable material may comprise monolithic materials (i.e., nonporous material comprising a breathable polymer), porous materials (i.e., polymer film with pores), and the like.

In a particularly preferred embodiment of the present invention, novel, improved flocked articles are made wherein at least one component of the flocked article comprises an ePTFE material, thereby imparting beneficial features to the flocked materials which were heretofore unachievable. For example, the ePTFE material may be present: (1) as at least one component of the substrate to which the flocked particulate is adhered; (2) as at least one component of the flock particulate; or (3) as at least one component of both the substrate and the flock material.

The flocked articles may have any desired geometry, such as a flexible sheet, a fabric, a flexible or rigid three-dimensional shape, a tube, and the like. Moreover, the configuration of the flocked articles may be either simple or complex, ranging from a single sheet to a layered structure to a three-dimensional structure, and having a homogeneous or multi-compositional form.

### BRIEF DESCRIPTION OF THE DRAWINGS

The foregoing summary, as well as the following detailed description of the invention, will be better understood when read in conjunction with the appended drawings. For purposes of illustrating the invention, there is shown in the drawings an embodiment which is presently preferred. It should be understood, however, that the invention is not limited to the precise arrangement and instrumentality shown. In the drawings:

FIGS. 1A and 1B are schematics of the cross-section of flocked articles which may be produced in the present invention;

FIG. 2 is a schematic of the cross-section of a flocked article which may be produced in the present invention;

FIG. 3 is a schematic of the cross-section of a flocked article which may be produced in the present invention;

FIG. 4 is a schematic of the cross-section of a flocked article which may be produced in the present invention; and

FIG. 5 is a side view of a flocked article which may be produced in the present invention.

### DETAILED DESCRIPTION OF THE INVENTION

The present invention relates to novel flocked articles which include as at least one component of the article a water resistant, wind resistant, breathable portion. The water resistant, wind resistant, breathable portion may be in the form of a membrane, layered structure or composite which is either porous or nonporous, which can also be air permeable or air impermeable, hydrophilic, hydrophobic and/or oleophobic. Moreover, the presence of a flock particulate layer on the surface of the article provides an increased surface area relative to articles which do not have a flocked surface.

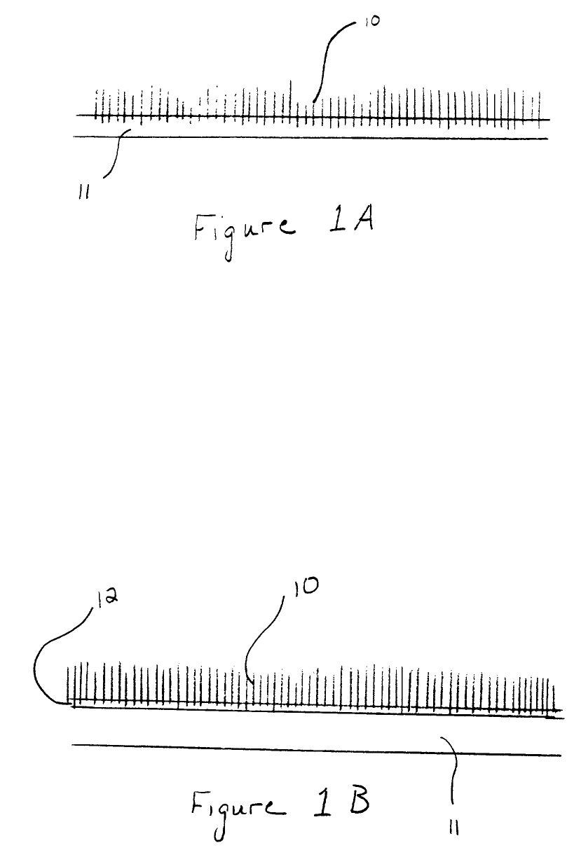

The articles of the present invention may comprise either simple or complex configurations. In one embodiment of the present invention, the novel flocked article may comprise a substrate material having flock particles attached, or fixed on position, to at least a portion of a surface of the substrate. As shown in FIG. 1A, the flock particles 10 may be attached to the substrate by at least partially embedding the particles within the substrate 11, or, alternatively, as shown in FIG. 1B, the flock particles 10 may be attached to the substrate 11 by adhering using one or more adhesive materials 12. In this embodiment, at least one of the substrate and the flock particles comprises a water resistant, wind resistant, breathable material.

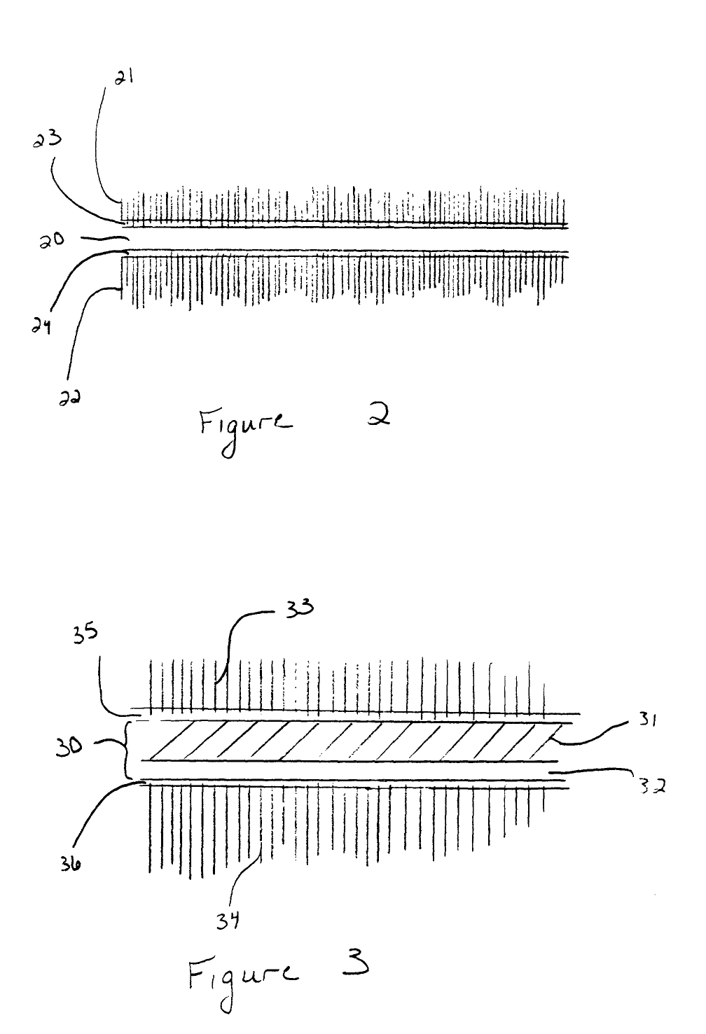

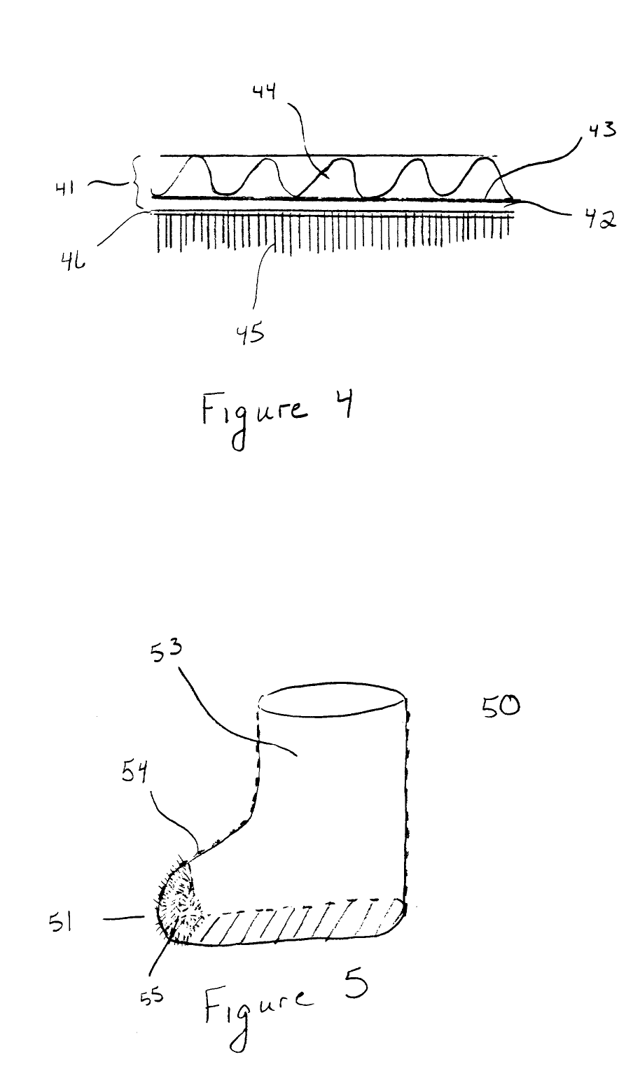

In an alternative embodiment of the present invention, the flocked article may comprise a more complex configuration, wherein the substrate may, for example, comprise one or more layers having the same or different compositions. Moreover the flock particles may be attached to only a portion of a surface of the substrate, may be attached to multiple surfaces of the substrate or may cover the entire surface of the substrate. For example, FIG. 2 shows a substrate 20 which contains flock particle layers 21 and 22 adhered by adhesive layers 23 and 24 to both sides of substrate 20. Alternatively, as shown in FIG. 3, the substrate 30 may comprise multiple layers 31 and 32, which may have either the same composition or different compositions, as shown, to which flock particle layers 33 and 34 are attached by adhesive layers 35 and 36, respectively. Moreover, it is contemplated that the configuration of the flocked article may be tailored to achieve a virtually unlimited combination of features and properties. For example, in one preferred embodiment, as shown in FIG. 4, the flocked article 40 may comprise a substrate 41 comprising a water resistant, wind resistant, breathable layer 42 adhered by adhesive layer 43 to an knit fabric layer 44, and the flocked particle layer 45 is adhered to the substrate 41 by adhesive layer 46. Thus, the resulting article comprises a flocked surface on one side of the article and a knit material on the other surface of the article.

In another embodiment of the present invention, the flocked article may comprise a complex, three-dimensional article having seams, holes, edges or the like which require sealing or reinforcement to, for example, insure water resistance and/or wind resistance. One technique to achieve this result may be to apply a sealing material, such as, for example, a water resistant tape over the stitching of a seam or over a hole. One example of a suitable sealing material is GORE-SEAM™ tape, available from W. L. Gore and Associates, Inc., Elkton, Md., which is adhered over the seam or hole in the article. Alternatively, such regions may be heat sealed to form a water resistant seal. The sealed article is then at least partially covered with a flock particulate layer, thus covering the sealed seam or region so that the sealed region is indistinguishable from the surrounding flocked surface of the article. For example, as shown in FIG. 5, a complex flocked article 50 comprising an inverted sock or boot having an interior surface 53 and a seam 54 is shown. Specifically, in this Figure, the toe portion 51 of the interior of the sock 50 includes a flock layer 55 covering the interior surface 53 and the seam 54 of the toe portion 51. Depending on the desired end use, either the entire surface or only selected portions of the article may include a flocked layer.

Substrates of the present invention may comprise a wide variety of compositions, ranging from natural to synthetic materials, and a virtually unlimited number of possible combinations may be envisioned. Suitable substrates may comprise natural or synthetic materials and may be in the form of fabrics, wovens, nonwovens, knits, films, membranes, papers, plastics, foams, suedes, pile, fleece, fur, and the like. Suitable materials for such substrates include, but are not limited to, nylons, cottons, rayons, acrylics, cellulose acetates, polymers such as polyesters, copolyesters, polytetrafluoroethylene, fluoroelastomers, polyurethanes including thermoplastic polyurethanes, block copolymers such as styrenics, copolyesterethers, copolyetheresteramides, fluoroelastomers and olefinics, copolyetherpolyesters, copolyetherurethanes, polyethylenes, polyethyleneimine, polypropylene, polycarbonates, polymethylmethacrylate, polyvinylchlorides, polyvinylidene fluoride, polysulfone, polystyrenes, polyamines, polyolefins, ultra-high molecular weight polyethylenes, modacrylics, aramids, wool, wood, metals, ceramics, flame retardant materials, materials comprising antimicrobial agents or functional agent, carbon, graphite, polyphenylene sulfide, fiberglass, rubbers, vinyls, leatherboard, treated substrates, such as those which are treated with a water repellent finish, and the like.

The substrate may have any desired geometry, such as a flexible sheet or fabric, a rigid or flexible three-dimensional shape, a tube, or the like. Moreover, the configuration of the substrate may be either simple or complex, ranging from a single, flat sheet to multi-layered and three-dimensional structures, and having a homogeneous or multi-compositional form.

The flock material of the present invention may be of any suitable length and/or thickness. For the purposes of the present invention, the term “flock particle” or “flock particulate” will be used herein for convenience and is meant to include particles of any aspect ratio and thus includes particles, chopped fibers, whiskers, powders, spheres, filaments or tows, aggregates, fibrils (i.e., finely divided, highly oriented offshoots from refining a larger filament), pulp, linter (e.g., very short, random cotton or wood), hollow fibers, filled fibers, coated fibers, microfibers, bristles, and the like. Moreover, the flock particles may be either random-cut or precision-cut to a specified length. Higher ratios of length to denier (L/D) result in a softer pile finish on the flocked surface.

A wide variety of flock materials may be used in the method of the present invention. For example, the flock particulates may be either natural or synthetic, and may comprise a wide variety of compositions such as, but not limited to, nylon, cotton, rayon, leather, acrylic, modacrylics, polymers such as polyesters, polyurethanes, polyethylenes, polypropylenes, polytetrafluoroethylenes, aramids, spandex, wool, wood, metals, ceramics, flame retardant materials, materials comprising antimicrobial agents or functional agent, materials which provide nuclear, biological and chemical protection (NBC), such as, for example, carbon fibers, carbon-filled materials and carbon-coated fillers, other coated flocks such as metal-coated or otherwise coated- flock, and mixtures thereof. Typical flock materials include polyesters, polypropylene, acrylics and modacrylics, cotton, aramids, carbon, polyphenylene sulfide, fiberglass, polytetrafluoroethylene, including expanded polytetrafluoroethylene, and metal-coated glass.

The sizes of the flock particulate can vary widely depending on the composition of the flock and the desired properties of the flocked articles. Exemplary sizes for the flock particulates range from 0.010 inch (o.254 mm) to 0.20 inch (5 mm) and exemplary ranges of denier (L/D)is from about 1.5 to about 20. However, depending on the desired use of the flocked articles of the present invention, the possible ranges may be even wider. Moreover, multiple sizes and/or dimensions of flock particulate may be combined in a given article to achieve a desired pattern or characteristic of the article.

In the case of flock particles which are in the form of filaments or tows, the filaments may be straight, curled, crimped or twisted to achieve a desired surface effect, although straight filaments are typically used to achieve a smooth finish to the flocked surface.

In a particularly preferred embodiment, the water resistant, wind resistant, breathable portion of the present invention comprises an ePTFE material, thereby imparting beneficial features to the flocked materials which were heretofore unachievable. For example, the ePTFE material may be present: (1) as at least one component of the substrate to which the flocked particulate is adhered; (2) as at least one component of the flock particulate; or (3) as at least one component of both the substrate and the flock material.

A preferred ePTFE material which may be used in the present invention comprises an ePTFE membrane which includes an expanded network of polymeric nodes and fibrils made in accordance with the teachings of the U.S. Pat. Nos. 3,953,566, 3,962,153, 4,096,227, 4,187,390 and 4,092,423. This material is commercially available in a variety of forms from W. L. Gore & Associates, Inc., of Elkton, Md., under the trademark GORE-TEX®.

As a flock particulate material, the ePTFE may have any desired size and denier required to meet a specific need. Moreover, more than one size of the ePTFE flock material may be used together to achieve a desired surface finish of the flock layer. Further, the ePTFE flock may be used in combination with other compositions of flock particulate to achieve, for example, water resistance, wind resistance, breathability and greater surface area, in combination with, for example, a specific appearance, surface texture, or the like.

In addition to the ePTFE being a component of the flock material, the ePTFE may be at least one component of the substrate. For example, the substrate may be a single sheet of expanded PTFE membrane to which the flock particulate is adhered on either one or both sides. Alternatively, the substrate may comprise a multi-layered structure in which one or more components comprise ePTFE. For example, a surface of an ePTFE substrate layer may be flocked either prior to or after attachment to another layer of the substrate, such as by lamination or other conventional technique. Alternatively, an ePTFE layer may be attached to a non-PTFE substrate layer either prior to or after flocking the non-PTFE substrate layer.

The flock particles may be attached to the substrate by either providing a separate adhesive material or by conditioning the surface of the substrate to have adhesive properties which permits the flock particles to adhere directly to the substrate without the use of an adhesive. For example, in the case of a substrate comprising a curable polymer, the surface of the substrate to be flocked may be provided in an uncured, “sticky” state such that the flock particles will adhere to the substrate. Subsequently, the substrate may be cured to a final state with the flocked layer securely adhered to the substrate.

Alternatively, the particles may be adhered to the substrate by an adhesive which is typically coated onto the substrate prior to the flocking process. Adhesives which may be used in the present invention can vary widely depending on the compositions of the flocking components, the flocking conditions used, the desired properties of the final articles, etc. Many suitable adhesives are available such as, for example, water and solvent based adhesives including polyvinyl acetate, styrene butadiene, butadiene acrylonitrile, acrylamides, epoxies, urethanes, those adhesives based on polyesters, particularly isocyanate-modified polyesters, or pure polyesters, in organic solvents, cross-linked with polyfunctional isocyanates, synthetic latex polymers such as self-cross-linking acrylics, plastisols, fluoropolymers, modified fluoropolymers, chemically reactive-, surface active- and absorptive polymers, conductive adhesives such as metal powder-filled adhesives (e.g., copper filled epoxy, and the like), flame retardant adhesives such as vinyl chloride polymers, acrylic and modacrylic adhesives, and the like.

The adhesive may be applied to the substrate by any of a number of conventional techniques, including silk-screening, stenciling, brushing, spraying, printing, roller coating, dipping, pressure application (i.e., in the case of pressure sensitive adhesives), knife-edge doctor blade application, electrostatic deposition, or any other suitable technique. Moreover, the adhesive may be applied in either a continuous or a discontinuous pattern.

Flocking of the flock particulate onto the substrate may be achieved by any suitable means, such as electrostatic, mechanical or other appropriate means. Generally, whatever the means, the process comprises depositing a mass of flock particulates onto the substrate and causing them to adhere thereto. The main types of suitable flocking process include (1) a mechanical process comprising spraying the fibers onto an adhesive-coated substrate, (2) a further mechanical process comprising sifting the fibers onto an adhesive-coated substrate and vibrating the substrate by the action of beater-bars to cause the fibers to stand on end and penetrate the adhesive, and (3) an electrostatic process in which the lines of force of an electrostatic field are used to propel and guide the fibers from a hopper to an adhesive-coated substrate, and (4) a combination of the electrostatic and mechanical processes set forth above.

As mentioned earlier herein, the flocked articles of the present invention may comprise either simple or complex geometries. For example, in a specific embodiment where large quantities of flocked fabric, such as roll goods, are to be made, it may be more convenient and/or economical to carry out the flocking step in a continuous manner over the surface of a fabric roll. Alternatively, in applications where complex flocked garments, such as gloves or socks are to be made, it may be more desirable to flock the articles after they are formed into the final shapes, thus allowing complete coverage with the flocked layer of otherwise complex configurations such as seams, corners, glove tips, and the like.

The novel flocked materials of the present invention may be used in a wide variety of textile applications. Specifically, the flocked materials of the present invention are appropriate for any textile applications which currently utilize flocked fabrics, but which would benefit from the added features that the water resistant, wind resistant, breathable components would contribute. Moreover, the present invention is also applicable for materials which do not conventionally include a flocked layer, but which require e.g., insulative or other properties which the novel flocked articles of the present invention may provide. Finally, the flocked articles of the present invention may be used in applications where the use of the flocked layer provides equivalent or better performance of the articles, while also providing cost advantages over conventional materials and formation techniques.

For example, a wide variety of beneficial uses of the novel flocked materials may include, but are not limited to garments, such as clothing and outerwear, including coats, jackets, pants, shirts, footwear, socks, hats, ear coverings, headbands, gloves, scarves, and the like, preferably to protect against the elements such as cold, wind, water, and the like. The novel flocked articles of the present invention may be incorporated into such garments to provide enhanced water resistance, wind resistance, breathability, insulation, tactility, wear resistance, fire resistance, chemical protection, noise reduction (e.g., for situations such as hunting and the like, where the water resistant, wind resistant, breathable materials provide equivalent or better performance, but with less noise during movement than the stiffer, louder materials which are conventionally used).

Moreover, as mentioned earlier herein, the flock particles may comprise or be coated with, for example, oleophobic materials, flame retardants, NBC protection materials, UV protectants, and abrasion resistant materials (e.g., Kevlar, etc.) to protect against specific environments or threats to which a person may be exposed.

Further, as mentioned earlier herein, the surface appearance of a flocked material may be tailored to achieve a desired density, surface finish, color, shading, pattern, tactility, weight, and the like, by, for example, combining flock particulate of varying sizes, compositions, colors, geometries, and the like.

Moreover, filled flock particles and/or filled substrates, such as those expanded PTFE materials made in U.S. Pat. No. 4,985,296, may be incorporated into the novel articles of the present invention to achieve a desired result. Alternatively, particulate materials, such as carbon and the like, may be adhered to one or more outer surface of the flock particulate, such as for example by the technique disclosed in U.S. Pat. No. 5,391,426, and other similar materials, in order to provide, for example, protective character to the flocked articles.

Further application for the novel articles of the present invention includes the fields of personal hygiene, such as for undergarments and the like, medical devices such as socks for orthopedic support, for cushioning such as in the case of diabetics with foot wounds or conditions, etc., cast inner liners, bandages with flocked surface to be placed be next to wounds, and other similar devices.

Moreover, the novel materials of the present invention may provide enhanced performance in a number of industrial applications, including filtration applications, providing not only increased surface area for adsorption/reaction, etc., but also depth filtration where there are gradations in the sizes of the openings, so that larger filtered particles are trapped at the external periphery of the flocked fibers, tailored wettability, gas diffusers in which the flocked surface of the diffuser prevents gas bubble coalescence on the surface, electrostatic air cleaners, bio-processing and the like.

Further, a variety of other miscellaneous industrial applications for the novel materials of the present invention are contemplated, such as controlled liquid delivery applications including office automation equipment and the like, fuel cells, enhanced sealing applications due to, for example, higher compressibility, better EMI shielding efficiency and, possibly, radar absorbency via the use of conductive flocked fibers, possibly in conjunction with a metallized expanded PTFE membrane.

The present invention provides a number of significant improvements over the flocked articles of the prior art. First, flocked fabrics made by the method of the present invention are expected to exhibit enhanced resilience, lighter weight, better tactility, better abrasion resistance, greater surface area and equal or better insulation properties and compared to conventional flocked fabrics.

Second, in filtration applications, the presence of a flocked surface can provide a significant increase in the surface area for filtration and retention of active fillers.

### Test Procedures

Breathability - Moisture Vapor Transmission Rate Test (MVTR)

In this procedure, approximately 70 ml. of a solution consisting of 35 parts by weight of potassium acetate and 15 parts by weight of distilled water was placed into a 133 ml. polypropylene cup, having an inside diameter of 6.5 cm at the mouth. An expanded polytetrafluoroethylene (PTFE) membrane having a minimum MVTR of approximately 60,000 g/m²/24 hrs as tested by the method described in U.S. Pat. No. 4,862,730 to Crosby using potassium acetate and available from W. L. Gore & Associates, Inc., of Newark, Del., was heat sealed to the lip of the cup to create a taut, leakproof, microporous barrier containing the solution.

A similar expanded PTFE membrane was mounted to the surface of a water bath. The water bath assembly was controlled at 23° C. plus or minus 0.2° C., utilizing a temperature controlled room and a water circulating bath.

The sample to be tested was allowed to condition at a temperature of 23° C. and a relative humidity of 50% prior to performing the test procedure. Samples were placed so the polymeric membrane, the applied adhesive surface, or the flock fibers were in contact with the expanded polytetrafluoroethylene membrane mounted to the surface of the water bath and allowed to equilibrate for at least 15 minutes prior to the introduction of the cup assembly.

The cup assembly was weighed to the nearest 1/1000 g. and was placed in an inverted manner onto the center of the test sample.

Water transport was provided by the driving force between the water in the bath and the saturated salt solution providing water flux by diffusion in that direction. The sample was tested for 15 minutes and the cup assembly was then removed and weighed again. The MVTR is calculated from the weight gain of the cup assembly and expressed in gm of water per square meter of sample surface area per 24 hours.

Water Resistance - Suter Test

Samples of materials were tested for water resistance by using a modified Suter test method, which is a low water entry pressure challenge. The test consists essentially of forcing water against one side of a test piece, and observing the other side of the test piece for indications of water penetration through it.

The sample to be tested is clamped and sealed between rubber gaskets in a fixture that holds the test piece inclined from the horizontal. The outer surface of the test piece faces upward and is open to the atmosphere, and to close observation. Air is removed from inside the fixture and pressure is applied to the inside surface of the test piece, over an area of 7.62 cm (3.0 inches) diameter, as water is forced against it. The water pressure on the test piece was increased to 1.1 psi by a pump connected to a water reservoir, as indicated by an appropriate gauge and regulated by an in-line air valve.

The outer surface of the test piece is watched closely for the appearance of any water forced through the material. Water seen on the surface is interpreted as a leak. A sample achieves a passing grade when, after 3 minutes, no water is visible on the surface.

Abrasion Resistance - Modified Universal Wear Abrasion Test

Samples were evaluated for abrasion resistance, as determined by water resistance durability, using a modified universal wear test method. The method is based on ASTM standard D3886-92 and consists essentially of abrading a sample with a selected abradent and determining the number of cycles until water leakage occurs as determined by the Suter test method.

The sample is abraded using a Commercial Inflated Diaphragm Abrasion Tester available from Custom Scientific Instruments in Cedar Knolls, N.J. (Model No. CS59-391). A two pound weight is used along with a 4 psig inflation pressure to accelerate the wear. Norton 600A 421 TUFBACK sand paper from Holloway Brothers is used as the abradent. The abradent is replaced every 150 cycles and at the start of a new sample.

Circular samples, 4.25 inch in diameter, are placed on the tester with the side to be abraded facing up. The sandpaper abradent is mounted on the upper assembly and lowered onto the inflated sample. The sandpaper is moved horizontally across the surface of the sample in a back and forth motion while the sample itself is being rotated 360° to ensure uniform wear in all directions. A single back and forth motion is denoted a “cycle”.

The sample is evaluated for visual wear every 150 cycles until membrane damage is observed. After membrane damage is first observed, the sample is tested for water leakage using the Suter test with the abraded side to the water. If the sample passes the Suter test, a new sample is abraded to a minimum of 150 cycles longer than the previous sample and then tested for water leakage. This is repeated until a failure is observed on the Suter test. After a sample fails the Suter test, a new sample is abraded a maximum of 50 cycles less than the leaking sample. This is repeated until a sample passes the Suter test. The number of cycles where leakage is first observed is then recorded.

Without intending to limit the scope of the present invention, the apparatus and method of using the present invention may be better understood by referring to the following examples:

### EXAMPLE 1

A first substrate, comprising a layer of expanded PTFE membrane, described in U.S. Pat. Nos. 3,953,566, 3,962,153 and 4,187,390, and a second substrate, comprising a first layer of expanded PTFE, a second layer of hydrophilic polyurethane, and a third layer of 1.5 oz. per yd.² nylon tricot knit, described in U.S. Pat. No. 4,194,041, were coated on the expanded PTFE with a layer of pressure sensitive adhesive from a roll backed with adhesive paper (Adhesives Research, Inc., Glen Rock, Pa.). Specifically, the roll of adhesive was unwound, exposing the adhesive layer, and the adhesive was then adhered to the expanded PTFE membrane side of the substrates by hand pressure. The substrates, with the release paper still in place, were then inserted between nip rolls to eliminate any air pockets which had formed during the adhering step. The release paper was then removed, leaving an open adhesive surface on each substrate.

Each coated substrate was then placed, with the adhesive side up, on a grounded metal plate in an air hood. A CP Electrostatic Flocking Unit, made by Cellusuede Products, Rockford, Ill., was then filled with a nylon conductive flocking fiber (Claremont Flock, Claremont, N.H.), and the unit was turned on. The unit was held and shaken over the substrate, and the flock particles deposited on the adhesive via the creation of an electrostatic charge between the unit and the metal plate. The entire surface of the substrate was covered with a layer of flocked particles, so that no surface of the substrate was visible upon inspection.

The flocked layer on the substrate appeared velvet-like and was soft and drapable. The first and second substrates were tested for abrasion resistance using the Modified Universal Wear Abrasion Test. The first substrate had a wear test cycles to leakage number of 75, and the second substrate had a wear test cycles to leakage number of greater than 350.

### EXAMPLE 2

The substrate comprising an expanded PTFE layer of Example 1, which had been coated on one side with a flocked layer was then coated on the other side of the substrate by repeating the technique of Example 1. Specifically, the unflocked side of the substrate was coated with a pressure sensitive adhesive, as described, and the unflocked side was coated with a nylon conductive flocking fiber, as described in Example1.

The resulting article comprised an expanded PTFE substrate coated on both sides with a flocked layer.

### EXAMPLE 3

The procedure of Example 1 was repeated, except that the adhesive comprised a spray adhesive comprising Super 77 aerosol, manufactured by 3M, Midland, Mich.

### EXAMPLE 4

A substrate material comprising a first layer of expanded PTFE, a second layer of hydrophilic polyurethane, and a third layer of 1.5 oz. per yd.² nylon tricot knit, described in U.S. Pat. No. 4,194,041, was cut and sewn in the shape of a sock, with the expanded PTFE layer on the interior portion of the substrate sock. The sock was inverted to reveal the membrane surface, and a foot form covered with a piece of aluminum foil was placed inside the inverted sock. The expanded PTFE surface of the sock was coated with a spray adhesive comprising Super 77 aerosol, manufactured by 3M, Midland, Mich.

A CP Electrostatic Flocking Unit, made by Cellusuede Products, Rockford, Ill., was then filled with a nylon conductive flocking fiber, and the unit was turned on. The unit was held and shaken over the substrate, and the flock particles deposited on the adhesive via the creation of an electrostatic charge between the unit and the metal plate. The entire surface of the substrate was covered with a layer of flocked particles.

The flocked layer on the substrate appeared velvet-like and was soft and drapable.

### EXAMPLE 5

Example 4 was repeated, except that the substrate material was cut and manufactured in the shape of a glove.

### Comparative Example 1

Laminates of three different constructions were made according to the steps listed below. Table 1a summarizes the compositions of the components of the three samples, referred to as samples 1A through 1C. Particularly, for each sample, an expanded polytetrafluoroethylene membrane, manufactured according to U.S. Pat. Nos. 3,953,566 and 4,187,390 and referred to as “ePTFE” with a weight of 6 g/m², a US101 polyester face fabric (Milliken and Co., Spartansburg, S.C.), and a reactive hot melt, hydrophilic polyurethane adhesive prepared according to the teachings of U.S. Pat. No. 4,532,316, were combined to form a laminate in accordance with the teachings of U.S. Pat. No. 5,026,591.

A 1.8 denier and 0.050 inch long Nylon flock fiber (Claremont Flock, Claremont, N.H.), hereafter referred to as “Nylon Flock 1”, and a 0.8 denier and 0.025 inch long Nylon flock fiber (Claremont Flock, Claremont, N.H.), hereafter referred to as “Nylon Flock 2”, were then adhered to the membrane by the procedure outlined in examples 8C and 8D of U.S. Pat. No. 5,026,591. Specifically, the fibers were mechanically sifted onto the coated surface of the laminate as the coated product was wrapped onto a core. The samples were allowed to ambient cure for at least 48 hours prior to testing.

Wear testing of samples 1A through 1C was carried out using the Modified Universal Wear Abrasion test, and the Moisture Vapor Transmission 5 Rate (MVTR) of each sample was also determined. Results are reported in Table 1.

TABLE 1

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 1A | US101 | ePTFE - | No Flock | Adhesive | 2 | 20900 |
| | | 6 g/m² | | | | |
| 1B | US101 | ePTFE - | Nylon | Flock | 1 | 15651 |
| | | 6 g/m² | Flock 1 | | | |
| 1C | US101 | ePTFE - | Nylon | Flock | 3 | 16514 |
| | | 6 g/m² | Flock 2 | | | |

### Comparative Example 2

The procedure of Comparative Example 1 was repeated except that a woven 50%/50% polyester cotton blend substrate was used as a face fabric in place of the US101 polyester fabric. Table 2 summarizes the compositions of the components of the samples referred to as samples 2D through 2F.

Wear testing of samples 2D through 2F was carried out using the Modified Universal Wear Abrasion test, and the Moisture Vapor Transmission Rate (MVTR) of each sample was also determined. Results are reported in Table 2.

TABLE 2

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 2D | 50/50 | ePTFE - | No Flock | Adhesive | 2 | 16462 |
| | Poly- | 6 g/m² | | | | |
| | cotton | | | | | |
| 2E | 50/50 | ePTFE - | Nylon | Flock | 2 | 14396 |
| | Poly- | 6 g/m² | Flock 1 | | | |
| | cotton | | | | | |
| 2F | 50/50 | ePTFE - | Nylon | Flock | 1 | 15061 |
| | Poly- | 6 g/m² | Flock 2 | | | |
| | cotton | | | | | |

### EXAMPLE 6

Laminates of three different constructions were made according to the steps listed below. Table 3 summarizes the compositions of the components of the three samples, referred to as samples 6A through 6C. Particularly, for each sample, an expanded polytetrafluoroethylene membrane manufactured according to U.S. Pat. Nos. 3,953,566 and 4,187,390 and referred to as “ePTFE” with a weight of 6 g/m², was laminated to a US101 polyester face fabric (Milliken and Co., Spartansburg, S.C.) using a polyurethane adhesive, prepared according to the teachings of U.S. Pat. No. 4,532,316, in a dot pattern.

The flock material, as specified in Table 3, was then adhered to the membrane by the procedure outlined below. Specifically, a reactive, hot melt hydrophilic polyurethane adhesive prepared according to the teachings of U.S. Pat. No. 4,532,316 was first applied directly to the membrane in a dot pattern. Immediately following the dot pattern adhesive application, a continuous coating of the same adhesive was applied over the dot pattern by passing the laminate through two chrome coating rolls set at a pre-determined gap to deliver a coating thickness of 0.003 inches. This process resulted in a laminate with a continuous coverage of adhesive applied directly to the membrane with a thickness of approximately 0.003 inches. The flock material was then applied to the adhesive by passing the substrate through a DC voltage electrostatic flocking hopper. The samples were allowed to ambient cure for at least 48 hours prior to testing.

Wear testing of samples 6A through 6C was carried out using the Modified Universal Wear Abrasion test, and the MVTR of each sample was also determined. Results are reported in Table 3.

TABLE 3

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 6A | US101 | ePTFE - | No Flock | Membrane | 1 | 33728 |
| | | 6 g/m² | | | | |
| 6B | US101 | ePTFE - | No Flock | Adhesive | 300 | 8708 |
| | | 6 g/m² | | | | |
| 6C | US101 | ePTFE - | Nylon | Flock | 4080 | 4143 |
| | | 6 g/m² | Flock 1 | | | |

### EXAMPLE 7

The procedure of Example 6 was repeated except that an expanded PTFE membrane with a weight of 17 g/m² was used. Table 4 summarizes the compositions of the components of the samples referred to as samples 7D through 7F.

Wear testing of samples 7D through 7F was carried out using the Modified Universal Wear Abrasion test, and the MVTR of each sample was also determined. Results are reported in Table 4.

TABLE 4

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| D | US101 | ePTFE - | No Flock | Membrane | 3 | 28751 |
| | | 17 g/m² | | | | |
| E | US101 | ePTFE | No Flock | Adhesive | 900 | 11601 |
| | | 17 g/m² | | | | |
| F | US101 | ePTFE | Nylon | Flock | 3450 | 5242 |
| | | 17 g/m² | Flock 1 | | | |

### EXAMPLE 8

Laminates of 3 different constructions were made according to the steps listed below. Table 5 summarizes the compositions of the components of the 3 samples, referred to as samples 8A through 8C. Particularly, for each sample, a membrane containing a hydrophobic layer and a continuous hydrophilic layer made in accordance with the teachings of U.S. Pat. No. 4,194,041, and referred to as “Layered Membrane” was laminated to a US101 polyester face fabric (Milliken and Co., Spartanburg, S.C.) using a polyurethane adhesive, prepared according to the teachings of U.S. Pat. No. 4,532,316, in a dot pattern.

The flock material specified in Table 5 was then adhered to the membrane by the procedure outlined below. Specifically, a reactive, hot melt polyurethane adhesive prepared according to the teachings of U.S. Pat. No. 4,532,316 was applied directly to the membrane in a discontinuous pattern with a surface coverage of adhesive of 55%. The flock material was then applied to the adhesive by passing the substrate through a DC voltage electrostatic flocking hopper. The samples were allowed to ambient cure for at least 48 hours prior to testing.

Wear testing of samples 8A through 8C was carried out using a Modified Universal Wear Abrasion test, and the MVTR of each sample was also determined. Results are reported in Table 5.

TABLE 5

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 8A | US101 | Layered | No Flock | Membrane | 30 | 14633 |
| | | Membrane | | | | |
| 8B | US101 | Layered | No Flock | Adhesive | 600 | 6839 |
| | | Membrane | | | | |
| 8C | US101 | Layered | Nylon | Flock | 1450 | 2922 |
| | | Membrane | Flock 1 | | | |

### EXAMPLE 9

The procedure of Example 8 was repeated, except that an expanded polytetrafluoroethylene membrane manufactured according to U.S. Pat. Nos. 3,953,566 and 4,187,390, referred to as “ePTFE,” with a weight of 17 g/m² was used. Table 6 summarizes the compositions of the components of the samples referred to as samples 9D through 9F.

Wear testing of samples 9D through 9F was carried out using a Modified Universal Wear Abrasion test, and the MVTR of each sample was also determined. Results are reported in Table 6.

TABLE 6

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 9D | US101 | ePTFE | No Flock | Membrane | 3 | 28751 |
| | | 17 g/m² | | | | |
| 9E | US101 | ePTFE | No Flock | Adhesive | 225 | 3003 |
| | | 17 g/m² | | | | |
| 9F | US101 | ePTFE | Nylon | Flock | 600 | 10166 |
| | | 17 g/m² | Flock 1 | | | |

### EXAMPLE 10

The procedure of Example 8 was repeated, except that an oleophobic expanded polytetrafluoroethylene membrane manufactured according to U.S. Pat. No. 5,375,441, and referred to as “Oleophobic ePTFE,” was used. Table 7 summarizes the compositions of the components of the samples referred to as samples 10G through 10I.

Wear testing of samples 10G through 10I was carried out using a Modified Universal Wear Abrasion test, and the MVTR of each sample was also determined. Results are reported in Table 7.

TABLE 7

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 10G | US101 | Oleo- | No Flock | Membrane | 2 | 28844 |
| | | phobic | | | | |
| | | ePTFE | | | | |
| 10H | US101 | Oleo- | No Flock | Adhesive | 325 | 14951 |
| | | phobic | | | | |
| | | ePTFE | | | | |
| 10I | US101 | Oleo- | Nylon | Flock | 600 | 10606 |
| | | phobic | | | | |
| | | ePTFE | Flock 1 | | | |

### EXAMPLE 11

The procedure of Example 8 was repeated except that an expanded polytetrafluoroethylene membrane manufactured according to U.S. Pat. Nos. 3,953,566 and 4,187,390 and referred to as “ePTFE,” with a weight of 6 g/m² was used. Table 8 summarizes the compositions of the components of the samples referred to as samples 11J through 11L.

Wear testing of samples 11J through 11L was carried out using a Modified Universal Wear Abrasion test, and the MVTR of each sample was also determined. Results are reported in Table 8.

TABLE 8

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 11J | US101 | ePTFE - | No Flock | Membrane | 1 | 33728 |
| | | 6 g/m² | | | | |
| 11K | US101 | ePTFE - | No Flock | Adhesive | 25 | 19667 |
| | | 6 g/m² | | | | |
| 11L | US101 | ePTFE - | Nylon | Flock | 625 | 10751 |
| | | 6 g/m² | Flock 1 | | | |

### EXAMPLE 12

Laminates of 3 different constructions were made according to the steps listed below. Table 9 summarizes the compositions of the components of the 3 samples, referred to as samples 12M through 12O. Particularly, for each sample, a commercially available copolyetherpolyester laminate sold under the trademark Sympatex® (Akzo Nobel, Germany), was used as the starting substrate.

The flock material specified in Table 9 was then adhered to the membrane by the procedure outlined below. Specifically, a reactive, hot melt polyurethane adhesive prepared according to the teachings of U.S. Pat. No. 4,532,316 was applied directly to the monolithic polyurethane membrane in a discontinuous pattern with a surface coverage of adhesive of 55%. The flock material was then applied to the adhesive by passing the substrate through a DC voltage electrostatic flocking hopper. The samples were allowed to ambient cure for at least 48 hours prior to testing.

Wear testing of samples 12M through 12O was carried out using the Modified Universal Wear Abrasion test, and the MVTR of each sample was also determined. Results are reported in Table 9.

TABLE 9

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 12M | n/a | Sympatex ® | No | Membrane | 1 | 7638 |
| | | | Flock | | | |
| 12N | n/a | Sympatex ® | No | Adhesive | 2 | 3454 |
| | | | Flock | | | |
| 12O | n/a | Sympatex ® | Nylon | Flock | 400 | 2071 |
| | | | Flock 1 | | | |

### EXAMPLE 13

The procedure of Example 13 was repeated except that a nylon Cordora face fabric (TapeTex, Inc., Rochester, N.Y.) was used in place of the US101 polyester fabric. Table 10 summarizes the compositions of the components of the samples referred to as samples 13A through 13C.

Wear testing of samples 13A through 13C was carried out using the Modified Universal Wear Abrasion test, and the MVTR of each sample was also determined. Results are reported in Table 10.

TABLE 10

| | | | | | Wear | |
|---|---|---|---|---|---|---|
| Sam- | | | | | Test | |
| ple | Laminate | Membrane | Flock | | Cycles | MVTR |
| Num- | Face | Descrip- | Com- | Abraded | to | g/m²/ |
| ber | Fabric | tion | position | Surface | Leakage | 24 hr |
| 13A | Cordora | Layered | No Flock | Membrane | 2 | 12533 |
| | | Membrane | | | | |
| 13B | Cordora | Layered | No Flock | Adhesive | 20 | 7898 |
| | | Membrane | | | | |
| 13C | Cordora | Layered | Nylon | Flock | 400 | 3419 |
| | | Membrane | Flock 1 | | | |

### EXAMPLE 14

The procedure of Example 9 was repeated except that a nylon Cordora face fabric (TapeTex, Inc., Rochester, N.Y.) was used in place of the US101 polyester fabric. Table 11 summarizes the compositions of the components of the samples referred to as samples 14D through 14F.

Wear testing of samples 14D through 14F was carried out using a Modified Universal Wear Abrasion test, and the MVTR of each sample was also determined. Results are reported in Table 11.

TABLE 11

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| 14D | Cordora | ePTFE- | No | Membrane | 1 | 12683 |
| | | 17 g/m² | Flock | | | |
| 14E | Cordora | ePTFE- | No | Adhesive | 30 | 10288 |
| | | 17 g/m² | Flock | | | |
| 14F | Cordora | ePTFE- | Nylon | Flock | 350 | 7765 |
| | | 17 g/m² | Flock 1 | | | |

### EXAMPLE 15

The procedure of Example 8 was repeated,except that a 1.3 oz./yd² polyester knit face fabric (Glen Raven Mills, Inc., Glen Raven, S.C.) was used in place of the US101 polyester fabric. Table 12 summarizes the compositions of the components of the samples referred to as samples 15A through 15C.

Wear testing of samples 15A through 15C was carried out using a Modified Universal Wear Abrasion test, and the MVTR of each sample was also determined. Results are reported in Table 12.

TABLE 12

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| 15A | 1.3 oz./ | Layered | No | Membrane | 2 | 15704 |
| | yd² knit | Membrane | Flock | | | |
| 15B | 1.3 oz./ | Layered | No | Adhesive | 100 | 7447 |
| | yd² knit | Membrane | Flock | | | |
| 15C | 1.3 oz./ | Layered | Nylon | Flock | 900 | 3391 |
| | yd² knit | Membrane | Flock 1 | | | |

### EXAMPLE 16

The procedure of Example 9 was repeated, except that a 1.3 oz./yd² polyester knit face fabric (Glen Raven Mills, Inc., Glen Raven, S.C.) was used in place of the US101 polyester fabric. Table 13 summarizes the compositions of the components of the samples referred to as samples 16D through 16F.

Wear testing of samples 16D through 16F was carried out using a Modified Universal Wear Abrasion test, and the MVTR of each sample was also determined. Results are reported in Table 13.

TABLE 13

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| 16D | 1.3 oz./ | ePTFE- | No | Membrane | 1 | 33473 |
| | yd² knit | 17 g/m² | Flock | | | |
| 16E | 1.3 oz./ | ePTFE- | No | Adhesive | 20 | 19719 |
| | yd² knit | 17 g/m² | Flock | | | |
| 16F | 1.3 oz./ | ePTFE- | Nylon | Flock | 320 | 12469 |
| | yd² knit | 17 g/m² | Flock 1 | | | |

### EXAMPLE 17

Laminates of 3 different constructions were made according to the steps listed below. Table 14 summarizes the compositions of the components of the 3 samples, referred to as samples 17A through 17C. Particularly, for each sample, a membrane containing a hydrophobic layer and a continuous hydrophilic layer made in accordance with the teachings of U.S. Pat. No. 4,194,041, and referred to as “Layered Membrane,” was laminated to a 1.3 oz./yd² polyester knit face fabric (Glen Raven Mills, Inc., Glen Raven, S.C.) using a polyurethane adhesive, prepared according to the teachings of U.S. Pat. No. 4,532,316, in a dot pattern.

The flock material specified in Table 14 was then adhered to the membrane by the procedure outlined below. Specifically, a commercially available reactive, hot melt polyurethane adhesive from H. B. Fuller Company (Product No. NP-2075 T) was applied directly to the membrane in a discontinuous pattern with a surface coverage of adhesive of 55%. The flock material was then applied to the adhesive by passing the substrate through a DC voltage electrostatic flocking hopper. The samples were allowed to ambient cure for at least 48 hours prior to testing.

Wear testing of samples 17A through 17C was carried out using a Modified Universal Wear Abrasion test, and the MVTR of each sample was also determined. Results are reported in Table 14.

TABLE 14

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| 17A | 1.3 oz./ | Layered | No | Membrane | 2 | 15704 |
| | yd² knit | Membrane | Flock | | | |
| 17B | 1.3 oz./ | Layered | No | Adhesive | 200 | 6868 |
| | yd² knit | Membrane | Flock | | | |
| 17C | 1.3 oz./ | Layered | Nylon | Flock | 400 | 3084 |
| | yd² knit | Membrane | Flock 1 | | | |

### EXAMPLE 18

Laminates of 3 different constructions were made according to the steps listed below. Table 15 summarizes the compositions of the components of the 3 samples, referred to as samples 18A through 18C. Particularly, for each sample, a membrane containing a hydrophobic layer and a continuous hydrophilic layer made in accordance with the teachings of U.S. Pat. No. 4,194,041, and referred to as “Layered Membrane,” was laminated to a US101 polyester face fabric (Milliken and Co., Spartansburg, S.C.) using a polyurethane adhesive, prepared according to the teachings of U.S. Pat. No. 4,532,316, in a dot pattern.

The flock material specified in Table 15 was then adhered to the membrane by the procedure outlined below. Specifically, a reactive, hot melt polyurethane adhesive prepared according to the teachings of U.S. Pat. No. 4,532,316 was applied directly to the membrane in a discontinuous pattern with a surface coverage of adhesive of 40%. The flock material was then applied to the adhesive by passing the substrate through a DC voltage electrostatic flocking hopper. The samples were allowed to ambient cure for at least 48 hours prior to testing.

Wear testing of samples 18A through 18C was carried out using a Modified Universal Wear Abrasion test, and the MVTR of each sample was also determined. Results are reported in Table 15.

TABLE 15

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| 18A | US101 | Layered | No | Membrane | 30 | 14633 |
| | | Membrane | Flock | | | |
| 18B | US101 | Layered | No | Adhesive | 90 | 9159 |
| | | Membrane | Flock | | | |
| 18C | US101 | Layered | Nylon | Flock | 260 | 3495 |
| | | Membrane | Flock 1 | | | |

### EXAMPLE 19

The procedure of Example 18 was repeated, except that an expanded polytetrafluoroethylene membrane manufactured according to U.S. Pat. Nos. 3,953,566 and 4,187,390, referred to as “ePTFE,” with a weight of 17 g/m² was used. Table 16 summarizes the compositions of the components of the samples referred to as samples 19D through 19F.

Wear testing of samples 19D through 19F was carried out using a Modified Universal Wear Abrasion test, and the MVTR of each sample was also determined. Results are reported in Table 16.

TABLE 16

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| 19D | US101 | ePTFE- | No | Membrane | 3 | 28751 |
| | | 17 g/m² | Flock | | | |
| 19E | US101 | ePTFE- | No | Adhesive | 6 | 19152 |
| | | 17 g/m² | Flock | | | |
| 19F | US101 | ePTFE- | Nylon | Flock | 150 | 10664 |
| | | 17 g/m² | Flock 1 | | | |

### EXAMPLE 20

The procedure of Example 18 was repeated, except that an oleophobic expanded polytetrafluoroethylene membrane manufactured according to U.S. Pat. No. 5,375,441, and referred to as “oleophobic ePTFE,” was used. Table 17 summarizes the compositions of the components of the samples referred to as samples 20G through 20I.

Wear testing of samples 20G through 20I was carried out using the Modified Universal Wear Abrasion test, and the MVTR of each sample was also determined. Results are reported in Table 17.

TABLE 17

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| 20G | US101 | Oleopho- | No | Membrane | 2 | 28844 |
| | | bic ePTFE | Flock | | | |
| 20H | US101 | Oleopho- | No | Adhesive | 15 | 17504 |
| | | bic ePTFE | Flock | | | |
| 20I | US101 | Oleopho- | Nylon | Flock | 130 | 10716 |
| | | bic ePTFE | Flock 1 | | | |

### EXAMPLE 21

The procedure of Example 18 was repeated, except that an expanded polytetrafluoroethylene membrane manufactured according to U.S. Pat. Nos. 3,953,566 and 4,187,390, referred to as “ePTFE,” with a weight of 6 g/m² was used. Table 18 summarizes the compositions of the components of the samples referred to as samples 21J through 21L.

Wear testing of samples 21J through 21L was carried out using a Modified Universal Wear Abrasion test, and the MVTR of each sample was also determined. Results are reported in Table 18.

TABLE 18

| | | | | | Wear | |
|---|---|---|---|---|---|---|
| | | | | | Test | |
| | Laminate | Membrane | Flock | | Cyles | MVTR |
| Sample | Face | Descrip- | Compo- | Abraded | to | g/m²/ |
| Number | Fabric | tion | sition | Surface | Leakage | 24 hr |
| J | US101 | ePTFE- | No | Membrane | 1 | 33728 |
| | | 6 g/m² | Flock | | | |
| K | US101 | ePTFE- | No | Adhesive | 5 | 21958 |
| | | 6 g/m² | Flock | | | |
| L | US101 | ePTFE- | Nylon | Flock | 75 | 17729 |
| | | 6 g/m² | Flock 1 | | | |

We claim:

1. A flocked article comprising
a substrate comprising expanded PTFE; and
at least one layer of flock particulate attached to at least a portion of said expanded PTFE to form a flocked surface, wherein said flocked surface has an abrasion to leakage value of at least 50 wear cycles.

2. The flocked article of claim 1, wherein said article further comprises at least one adhesive layer attaching said flock particulate to said expanded PTFE.

3. The flocked article of claim 1, wherein said flocked surface has an abrasion to leakage value of at least 75 wear cycles.

4. The flocked article of claim 1, wherein said flocked surface has an abrasion to leakage value of at least 200 wear cycles.

5. The flocked article of claim 1, wherein said flocked surface has an abrasion to leakage value of at least 500 wear cycles.

6. The flocked article of claim 1, wherein said flocked surface has an abrasion to leakage value of at least 1000 wear cycles.

7. The flocked article of claim 1, wherein said flocked surface has an abrasion to leakage value of at least 2000 wear cycles.

8. The flocked article of claim 1, wherein said flocked surface has an abrasion to leakage value of at least 3000 wear cycles.

9. The flocked article of claim 1, wherein said flocked surface has an abrasion to leakage value of at least 4000 wear cycles.

10. The flocked article of claim 1, wherein said substrate further comprises at least one fabric selected from the group consisting of wovens, nonwovens and knits.

11. The flocked article of claim 1, wherein said substrate further comprises at least one material selected from the group consisting of foams, films, membranes and paper.

12. The flocked article of claim 10, wherein said at least one fabric further comprises at least one of a suede surface, a pile surface and a fleece surface.

13. The flocked article of claim 1, wherein said substrate further comprises at least one material selected from the group consisting of nylons, polyesters, cottons, rayons, acrylics, cellulose acetates, wool, carbon, fiberglass, rubber, vinyl and leatherboard.

14. The flocked article of claim 1, wherein said at least one layer of flock particulate comprises at least one material selected from the group consisting of nylons, cottons, polyesters, modacrylics, aramids, rayons, acrylics, cellulose acetates, wool, carbon, fiberglass, rubber, vinyl and leatherboard.

15. The flocked article of claim 1, wherein said substrate further comprises at least one material selected from the group consisting of polyesters, copolyesters, fluoroelastomers, block copolymers, copolyesterethers, copolyetheresteramides, olefinics, copolyetherpolyesters, copolyetherurethanes, polyethylenes, polyamides, polyethyleneimine, polyamines, polypropylene, polycarbonates, polymethylmethacrylate, polyvinylchlorides, polyvinylidene fluoride, polysulfone, polystyrenes, polyolefins, modacrylics, aramids and polyacrylonitriles.

16. The flocked article of claim 1, wherein said at least one layer of flock particulate comprises at least one polymer selected from the group consisting of polyesters, copolyesters, fluoroelastomers, block copolymers, copolyesterethers, copolyetheresteramides, olefinics, copolyetherpolyesters, copolyetherurethanes, polyethylenes, polypropylene, polycarbonates, polymethylmethacrylate, polyvinylchlorides, polyvinylidene fluoride, polysulfone, polystyrenes, polyolefins, modacrylics, aramids and polyacrylonitriles.

17. The flocked article of claim 2, wherein said at least one adhesive layer comprises at least one material selected from the group consisting of acrylics, acrylamides, epoxies, silicones, urethanes, polyesters, polyesters cross-linked with polyfunctional isocyanates and fluoropolymers.

18. The flocked article of claim 2, wherein said at least one adhesive layer comprises a continuous layer of adhesive.

19. The flocked article of claim 2, wherein said at least one adhesive layer comprises a discontinuous layer of adhesive.

20. The flocked article of claim 2, wherein said at least one adhesive layer comprises a foamed layer of adhesive.

21. The flocked article of claim 1, wherein said expanded PTFE further comprises an oleophobic coating on at least a portion thereof.

22. The flocked article of claim 1, wherein said expanded PTFE further comprises a hydrophilic coating on at least a portion thereof.

23. The flocked article of claim 1, wherein said article has a moisture vapor transmission rate of at least 2000 g/m²/day.

24. The flocked article of claim 1, wherein said article has a moisture vapor transmission rate of at least 7500 g/m²/day.

25. The flocked article of claim 1, wherein said article has a moisture vapor transmission rate of at least 10,000 g/m²/day.

26. The flocked article of claim 1, wherein said article has a moisture vapor transmission rate of at least 15,000 g/m²/day.

27. A flocked article comprising:
a substrate having a first side and a second side wherein said first side comprises a water resistant, wind resistant breathable material; and
at least one layer of flock particulate attached to at least a portion of said first side; wherein said article has an abrasion to leakage value of at least 50 cycles.

28. The flocked article of claim 27, wherein said water resistant, wind resistant breathable material is selected from the group consisting of polyesters, polyurethanes, and polyolefins

29. The flocked article of claim 28, wherein said water resistant, wind resistant breathable material comprises copolyetherpolyester.

30. The flocked article of claim 28, wherein said water resistant, wind resistant breathable material comprises polyether polyurethane.

31. The flocked article of claim 27, said flocked surface has an abrasion to leakage value of at least 100 wear cycles.

32. The flocked article of claim 27, wherein said flocked surface has an abrasion to leakage value of at least 500 wear cycles.

33. The flocked article of claim 27, wherein said flocked surface has an abrasion to leakage value of at least 1000 wear cycles.

34. The flocked article of claim 27, wherein said flocked surface has an abrasion to leakage value of at least 2000 wear cycles.

35. A flocked article comprising
a substrate having at least a first side and a second side wherein said first side comprises expanded PTFE;
at least one layer of flock particulate attached to at least a portion of said first side; and
at least one layer of flock particulate attached to at least a portion of said second side.

36. The flocked article of claim 35, wherein said flocked surface has an abrasion to leakage value on said first side of at least 50 wear cycles.

37. The flocked article of claim 35, wherein said flocked surface has an abrasion to leakage value on said first side of at least 500 wear cycles.

38. The flocked article of claim 35, wherein said flocked surface has an abrasion to leakage value on said first side of at least 1000 wear cycles.

39. The flocked article of claim 35, wherein said second side comprises expanded PTFE.

40. The flocked article of claim 35, further comprising at least one adhesive attaching said flock particulate to at least one of said first side and said second side.

41. A flocked article comprising
a substrate comprising expanded PTFE membrane having a coating of water resistant, moisture vapor permeable material, and
at least one layer of flock attached to at least a portion of the coated membrane, wherein said flocked surface has an abrasion to leakage value of at least 50 wear cycles.

42. The flocked article of claim 41, wherein said flocked surface has an abrasion to leakage value of at least 500 wear cycles.

43. The flocked article of claim 41, wherein said flocked surface has an abrasion to leakage value of at least 1000 wear cycles.

44. A flocked article comprising
a substrate; and
at least one layer of flock particulate comprising expanded PTFE attached to at least a portion of said substrate.

45. The flocked article of claim 44, further comprising at least one adhesive layer.

46. The flocked article of claim 44, wherein said substrate comprises multiple layers.

47. The flocked article of claim 44, wherein said substrate comprises at least one fabric selected from the group consisting of wovens, nonwovens and knits.

48. The flocked article of claim 44, wherein said substrate comprises at least one material selected from the group consisting of foams, films, membranes and paper.

49. The flocked article of claim 1 in the form of a water resistant, wind resistant, breathable garment.

50. The flocked article of claim 27 in the form of a water resistant, wind resistant, breathable garment.

51. The flocked article of claim 35 in the form of a water resistant, wind resistant, breathable garment.

52. The flocked article of claim 44 in the form of a water resistant, wind resistant, breathable garment.
